(19) United States
(12) Patent Application Publication
(10) Pub. No.: US 2025/0332884 A1
(43) Pub. Date: Oct. 30, 2025

(54) METHOD AND DEVICE FOR CONTROLLING REFRIGERATION SYSTEM OF VEHICLE

(71) Applicants: Hyundai Motor Company, Seoul (KR); Kia Corporation, Seoul (KR)

(72) Inventors: Hyeonseob Kim, Hwaseong-si (KR); Gwangseob Kim, Hwaseong-Si (KR); Sae Yong Jang, Hwaseong-si (KR); Jungmo Yu, Hwaseong-si (KR); Dokon Kim, Hwaseong-Si (KR); Chan Seok Choi, Hwaseong-Si (KR)

(21) Appl. No.: 18/960,201

(22) Filed: Nov. 26, 2024

(30) Foreign Application Priority Data
Apr. 24, 2024 (KR) 10-2024-0054469

(51) Int. Cl. B60H 1/00

(52) U.S. Cl. CPC B60H 1/00978; B60H 1/00814; B60H 1/00985

(57) ABSTRACT

A method for controlling a refrigeration system of a vehicle, which controls a freezer controlling a temperature of a freezing room when the refrigeration system installed in the vehicle malfunctions, includes: detecting a failure of the refrigeration system; receiving a predefined current consumption map for the refrigeration system; when a failure of the refrigeration system is detected, calculating an in-failure operating current amount for controlling an operation of the freezer during a failure based on a current consumption derived from the current consumption map; and transmitting both the in-failure operating current amount and an operating command of the freezer to a power supply device of the freezer to switch an operation mode of the refrigeration system from a normal operation mode to an in-failure operation mode so that the power supply device limits power used in a heat exchanger. A device may be configured to perform the method.

### CROSS-REFERENCE TO RELATED APPLICATION

This application claims priority to and the benefit of Korean Patent Application No. 10-2024-0054469 filed in the Korean Intellectual Property Office on Apr. 24, 2024, the entire contents of which are incorporated herein by reference.

### TECHNICAL FIELD

The disclosure relates to a method and device for controlling a refrigeration system of a vehicle, and more particularly, to a method and device for controlling a refrigeration system of a vehicle when a failure of the refrigeration system of a vehicle occurs.

### BACKGROUND

A Purpose Built Vehicle (PBV) is a vehicle designed for a particular purpose of use. In other words, a PBV, unlike general passenger vehicles, is designed and manufactured to suit a specific purpose or requirement, and may be a vehicle manufactured based on a special function or purpose. A PBV may be a modular vehicle configured to operate by electronic motorization. Refrigeration vehicles may be special vehicles used to transport temperature-sensitive goods, such as food, pharmaceuticals, and/or biochemical or chemical products. Refrigeration vehicles are equipped with cooling systems that may precisely control internal temperatures to ensure that goods remain in proper conditions until they reach a destination. Such refrigeration vehicles have recently been developed based on PBVs for eco-friendly purposes, and linked solutions and services are also provided.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for controlling a refrigeration system of a vehicle. A method for controlling a refrigeration system of a vehicle may comprise: detecting a failure of the refrigeration system comprising a freezer configured to control a temperature of a freezing room of the refrigeration system; receiving a current consumption map, for the refrigeration system, mapping current amounts to target temperatures of the freezing room; based on the detected failure of the refrigeration system, determining, using the current consumption map, an in-failure operating current amount for controlling an operation of the freezer of the refrigeration system during the failure; and transmitting, to a power supply device of the freezer: the in-failure operating current amount, and an operating command configured to cause the power supply device to switch from a normal operation mode to an in-failure operation mode in which the power supply device limits, relative to the normal operation mode, power used in a heat exchanger of the freezer.

A device for controlling a refrigeration system of a vehicle may comprise: one or more processors; and one or more memory devices comprising at least one instruction that, when executed by the one or more processors, is configured to cause the device to: detect a failure of the refrigeration system comprising a freezer configured to control a temperature of a freezing room of the refrigeration system; receive a current consumption map, for the refrigeration system, mapping current amounts to target temperatures of the freezing room; based on the detected failure of the refrigeration system, determine, using the current consumption map, an in-failure operating current amount for controlling an operation of the freezer of the refrigeration system during the failure; and transmit, to a power supply device of the freezer: the in-failure operating current amount, and an operating command configured to cause the power supply device to switch an operation mode of the refrigeration system from a normal operation mode to an in-failure operation mode in which the power supply device limits, relative to the normal operation mode, power used in a heat exchanger of the freezer.

These and other features and advantages are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 is a block diagram illustrating a device for controlling a refrigeration system of a vehicle according to an example.

FIG. 2 is a flowchart illustrating a method for controlling a refrigeration system of a vehicle according to an example.

FIG. 3 is a diagram illustrating an implementation example of a device for controlling a refrigeration system of a vehicle according to an example.

FIG. 4 is a diagram illustrating an implementation example of a device for controlling a refrigeration system of a vehicle according to an example.

FIG. 5 is a diagram illustrating an implementation example of a method for controlling a refrigeration system of a vehicle according to an example.

FIG. 6 is a diagram illustrating an implementation example of a device for controlling a refrigeration system of a vehicle according to an example.

FIG. 7 is a diagram illustrating a computing device according to an example.

### DETAILED DESCRIPTION

Hereinafter, the disclosure will be described with reference to the accompanying drawings, in which examples of the present disclosure are shown. As those skilled in the art would realize, the described examples may be modified in various different ways, all without departing from the spirit or scope of the disclosure. Accordingly, the drawings and description are to be regarded as illustrative in nature and not restrictive. Like reference numerals designate like elements throughout the specification and drawings.

Throughout the specification and claims, unless explicitly described to the contrary, the words “comprise”, “has”, “includes”, etc., and variations thereof, will be understood to imply the inclusion of stated elements but not the exclusion of any other elements. It will be understood that, although the terms “first”, “second”, etc. may be used herein to describe various elements, these elements should not be limited by these terms. These terms are only used to distinguish one element from another.

The terms “part”, “unit”, and “module” herein should be understood to refer to a unit capable of processing at least one function or operation described in this specification and may be implemented by hardware or circuit, software, or a combination of a hardware or circuit and software. In addition, at least some components or functions of the method and device for controlling a refrigeration system of a vehicle according to examples described below may be implemented as a program or software, and the program or software may be stored in a computer-readable medium.

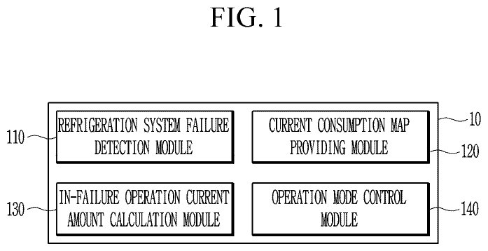

FIG. 1 is a block diagram illustrating a device for controlling a refrigeration system of a vehicle according to an example.

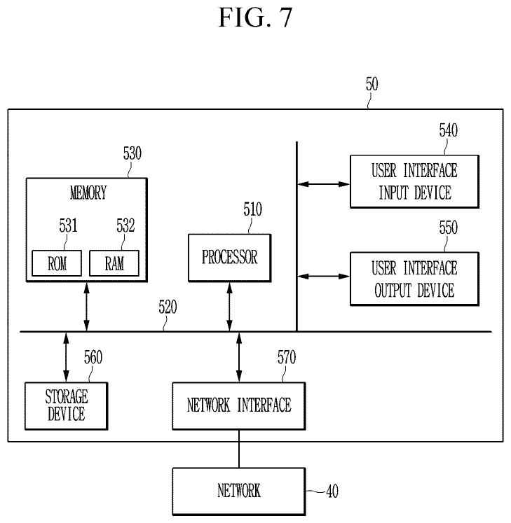

Referring to FIG. 1, a device 10 for controlling a refrigeration system of a vehicle according to an example may execute, via one or more processors, program codes loaded in one or more memory devices. For example, the device 10 for controlling a refrigeration system of a vehicle may be implemented as a computing device 50, as described herein with reference to FIG. 7. One or more processors may correspond to a processor 510 of the computing device 50. One or more memory devices may correspond to a memory 520 of the computing device 50. The program code may be executed by one or more processors to control a freezer that regulates the temperature of a freezing room if a refrigeration system installed in the vehicle malfunctions (is determined to be malfunctioning/in-failure). The term “module” herein is used to logically distinguish different functions performed by program code from each other.

The device 10 for controlling a refrigeration system of a vehicle, according to an example, may execute program code including a refrigeration system failure detection module 110, a current consumption map providing module 120, an in-failure operating current amount calculation module 130 during a failure, and an operation mode control module 140.

The refrigeration system failure detection module 110 may detect a failure of the refrigeration system (e.g., while the vehicle is in operation). Refrigeration systems applied to commercial vehicles may be equipped with temperature sensors for a target operation (e.g., target temperature operation). For example, in a refrigeration system, the temperature sensor may be installed in a freezing room, outside the refrigeration system, or both inside the freezing room and outside the refrigeration system. The freezing room temperature sensor may measure a current temperature of the freezing room, and the temperature sensor installed and operating outside the refrigeration system may measure the outside temperature of the vehicle. The refrigeration system failure detection module 110 may detect a failure of the freezing room temperature sensor and/or detected by/based on the freezing room temperature sensor or other temperature sensor (e.g., while the vehicle is in operation).

In some examples, the refrigeration system failure detection module 110 may determine that the refrigeration system malfunctions based on a failure signal being received from the freezing room temperature sensor. Here, the failure signal may include one or more predefined failure signals that the freezing room temperature sensor may output to another element, such as the device 10 for controlling a refrigeration system of a vehicle. The one or more predefined failure signals may indicate one or more corresponding situations have occurred/are occurring. For example, the one or more failure signals may include various types of failure signals such as a temperature deviation signal indicating that an actual temperature is outside a preset range, a sensor error signal indicating a failure or malfunction of the temperature sensor itself, a communication error signal indicating that temperature data is not transmitted normally, and a mechanical damage signal indicating the occurrence of a physical shock or damage.

In some examples, the refrigeration system failure detection module 110 may detect a failure of the refrigeration system by directly tracking a temperature (e.g., temperature change) in the freezing room. That is, the refrigeration system failure detection module 110 may receive a temperature value from the freezing room temperature sensor and track a temperature and/or temperature change in the freezing room. If the temperature change is determined to be an abnormal change and/or the temperature is determined to be an abnormal temperature, refrigeration system failure detection module 110 may determine that the refrigeration system is malfunctioning/has malfunctioned. The abnormal temperature and/or temperature change may indicate the temperature of the freezing room exceeds and/or is outside of a preset range and/or shows a change pattern that is not associated with normal operation of the refrigeration system (e.g., operation without a failure).

The current consumption map providing module 120 may provide a predefined current consumption map regarding/associated with the refrigeration system. The current consumption map may include the amount of current (e.g., expected current consumption) required/expected to achieve a target internal temperature of the freezing room. The amount of current may be determined in consideration of various parameters/factors associated with operation of the refrigeration vehicle and/or situations in which the refrigeration vehicle operates.

In some examples, in the current consumption map, a current amount associated with/corresponding to (e.g., required to achieve) the target internal temperature of the freezing room may be defined/determined/calculated based on at least one of an external temperature of the refrigeration system, an internal temperature of the freezing room, a target internal temperature of the freezing room, and a type of cargo loaded into the freezing room. The type of cargo may be considered because various properties thereof, including heat capacity, volume, etc., may be different depending on the type of cargo (e.g., ice cream, frozen fish, frozen processed food, etc.). In some examples, the current consumption map may include a current amount defined based on a difference in temperature between external air (e.g., external to the refrigeration system and/or to the freezer room) and internal air (e.g., of the freezer room) may be calculate using an external temperature of the refrigeration system and an internal temperature of the freezing room. The term current amount used in the present specification may refer to the amount of current per hour (i.e., in ampere per hour (A/h)). In some examples, the current consumption map may be implemented with a data structure. For example, the current consumption map may be a data structure in the form of a three-dimensional (3D) array and may be defined based on a first axis (e.g., an X axis) representing a difference between the internal temperature of the freezing room and the external temperature of the refrigeration system, a second axis (e.g., a Y axis) representing the target internal temperature of the freezing room, and a third axis (e.g., a Z axis) representing the type of cargo loaded in the freezing room.

The current consumption map may be loaded/stored in a memory device for access (e.g., by the device 10). The current consumption map may be stored in separate memory device from, or a same memory device together with, program code configured to implement at least some of the refrigeration system failure detection module 110, the current consumption map providing module 120, the in-failure operating current amount calculation module 130, and/or the operation mode control module 140.

The current consumption map may be configured/generated via theoretical techniques and/or may experimental techniques/data. For the current consumption map configured via theoretical techniques, a heat loss amount and a cooling amount of the freezer may be calculated/determined based on analysis of the refrigeration system of the vehicle, and a net cooling amount may be derived from a difference between the heat loss amount and the cooling amount. Based on net power for lowering a unit temperature per unit time being calculated, the amount of power required to achieve the target temperature may be calculated to determine the expected current consumption of the current consumption map. For the current consumption map configured via experimental techniques, an experimental temperature difference conditions outside the vehicle and inside the freezing room in a test facility may be generated/applied, and time and power required to achieve the target temperature may be measured by operating the refrigerator to determine the expected current consumption of the current consumption map. The current consumption map may be configured to have different expected current consumption values depending on the type of cargo loaded into the freezing room. For example, frozen fish has a high density, whereas ice cream has a high air content to have a relatively low density, and thus, the different expected current consumption values are to reflect unique characteristics of cargo. As another example, semi-dry products have relative low moisture content, which may also affect the current required to adjust a temperature of the freezer room containing such products. Thus, a more detailed expected current consumption value may be set by considering the unique characteristics of the cargo.

If a failure of the refrigeration system is detected, the in-failure operating current amount calculation module 130 may calculate the amount of operating current during a failure (i.e., the in-failure operating current amount) to control the operation of the freezer during a failure, based on the current consumption derived from the current consumption map. The in-failure operating current amount calculation module 130 may acquire a current amount (or an expected current consumption) corresponding to the situation (e.g., external/internal temperature difference, type of cargo, etc.) by searching the current consumption map using at least one of a temperature difference between the external and internal air of the freezer, the target internal temperature of the freezing room, and the type of cargo loaded in the freezing room when the refrigeration vehicle is operating. For example, if the current consumption map is implemented as a data structure in the form of a 3D array, the in-failure operating current amount calculation module 130 may acquire the current amount (or the expected current consumption) corresponding to the situation in which the refrigeration vehicle operates by searching the current consumption map including the first (e.g., X) axis, the second (e.g., Y) axis, and the third (e.g., Z) axis. The in-failure operating current amount calculation module 130 may apply a correction factor for considering/based on a cargo volume loaded in the freezing room to the current consumption and calculate the current consumption to which the correction factor is applied as the in-failure operating current amount.

In some examples, the correction factor may be calculated according to the following equation 1:

$$Correction factor = Weight of refrigerated cargo volume / Basic weight used when creating current consumption map \qquad ( Equation 1 )$$

That is, considering the weight of the refrigerated cargo volume loaded in the freezing room, a final amount of current required per hour may be calculated by multiplying a freezer operating current amount per unit weight by the correction factor.

The operation mode control module 140 may transmit the in-failure operating current amount calculated by the in-failure operating current amount calculation module 130 and an operation command for controlling the operation of the freezer to the power supply device of the freezer. The freezer may include the power supply device and a heat exchanger. The power supply device may supply necessary power to various components, such as a compressor inside/of the freezer. Accordingly, the compressor may start a refrigeration cycle by compressing a refrigerant, and the refrigerant may be converted from a gas state to a high pressure and high temperature state. The compressed refrigerant may move to the heat exchanger, and the refrigerant may be heat-exchanged with surrounding air in the heat exchanger to discharge heat and may be condensed into a liquid state. As the power supply and heat exchange process are repeated, continuous cooling may be implemented. While transmitting an operation command for operating the freezer to the power supply device, the operation mode control module 140 may also transmit the in-failure operating current amount to the power supply device (e.g., as data in a predetermined format).

The power supply device may supplying power according to the operation command received from the operation mode control module 140. The power supply device may read the data received from the operation mode control module 140 and access the in-failure operating current amount value calculated by the in-failure operating current amount calculation module 130. The power supply device may limit the power used by the heat exchanger, depending on the value of the in-failure operating current amount.

The operation mode control module 140 may switch the operation mode of the refrigeration system from a normal operation mode to an in-failure operation mode. The in-failure operation mode may be an operation mode in which the power supply device of the freezer operates with limited/reduced power used in the heat exchanger.

According to the present example, normal refrigeration system operation may refer to operation of the freezer implemented via feedback control based on the temperature of the freezing room. If a failure of the refrigeration system is detected (e.g., while the vehicle is in operation), the power of the freezer may be switched to control power to operate the freezer based on a constant current amount. The in-failure operating current amount may be determined considering the internal temperature of the freezing room before the detected failure, the external temperature of the refrigeration system, and/or the type of cargo loaded in the freezing room. A level to which the power is to be limited may be determined according to the in-failure operating current amount. Accordingly, even if a situation occurs (e.g., during vehicle operation) in which it is impossible/difficult to measure the temperature of the freezing room and/or it is difficult to operate the freezer based on the freezing room temperature-based feedback control, the freezer may be operated in a restricted state for a certain period of time (e.g., even considering/accounting for the characteristics of the refrigerated cargo loaded in the freezing room). Therefore, not only may refrigerated cargo be prevented from being thawed or excessively frozen to be damaged, but it is also possible to temporarily operate the vehicle for a given time and/or to a destination without making an emergency turn and/or stop, thereby minimizing economic and time loss that may occur when the refrigeration system malfunctions (e.g., while the vehicle is in operation).

In some examples, if a failure of the refrigeration system is detected (e.g., while the vehicle is in operation) or if the freezer is operated in the in-failure operation mode, a notification indicating that the refrigeration system is operating during a failure may be output by (e.g., displayed on) one or more interfaces (e.g., a plurality of interfaces, for example, a cluster, a center fascia, and/or an in-vehicle display device) installed in the vehicle and/or in communication with the vehicle (e.g., a mobile device of a user of the vehicle).

In some examples, if a predetermined time limit has lapsed since the operation mode of the refrigeration system was switched to the in-failure operation mode, the operation mode control module 140 may terminate the in-failure operation mode. For example, the operation mode control module 140 may (e.g., automatically) initialize the settings of the power supply device (e.g., that has been operated with limited power according to the in-failure operation mode) by setting a limit time to be a time longer than a scheduled arrival time of the vehicle to a destination or maintenance center (e.g., at which point it may be assumed the refrigeration system may receive maintenance, and the concern for damage to the refrigerated cargo is expected to be resolved). After the set limit time has elapsed (e.g., at which point the concern about damage to the refrigerated cargo is expected to be resolved), the power limitation of the power supply device of the freezer may be automatically released. A notification regarding termination of the in-failure operation mode may be output by one or more interfaces (e.g., a plurality of interfaces installed in the vehicle, such as a cluster, center fascia, and display device in the vehicle, and/or in communication with the vehicle, such as a mobile device of a user of the vehicle).

In some examples, based on the failure being resolved, the operation mode control module 140 may switch the operation mode of the refrigeration system from the in-failure operation mode to the normal operation mode. A notification indicating the switch from the in-failure operation mode to the normal operation mode may be output by the one or more devices (e.g., the plurality of interfaces, such as a cluster, a center fascia, and an in-vehicle display device, installed in the vehicle).

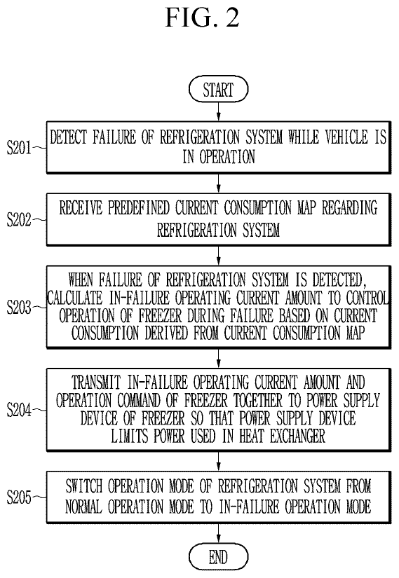

FIG. 2 is a flowchart illustrating a method for controlling a refrigeration system of a vehicle according to an example.

Referring to FIG. 2, a method for controlling a refrigeration system of a vehicle according to an example may include detecting a failure of the refrigeration system (e.g., while the vehicle is in operation, such as in transit, loaded with cargo, etc.) (S201), receiving a current consumption map regarding the refrigeration system (S202), based on a failure of the refrigeration system being detected, calculating/determining an in-failure operating current amount to control the operation of the freezer during the failure based on a current consumption derived/determined from/based on the current consumption map (S203), transmitting the in-failure operating current amount and an operation command of the freezer together to a power supply device of the freezer so that the power supply device limits power used in a heat exchanger (S204), and switching an operation mode of the refrigeration system from a normal operation mode to an in-failure operation mode (S205).

For more detailed information on the method for controlling a refrigeration system of a vehicle, the examples described in this specification may be referred to, so redundant description will be omitted here.

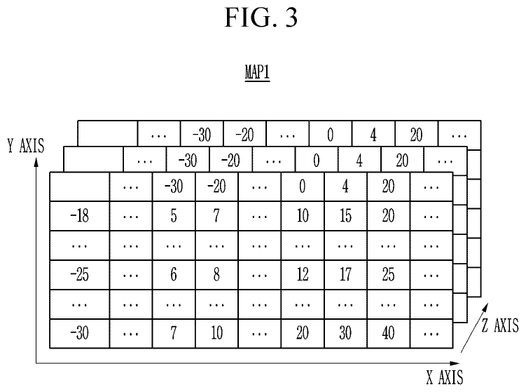

FIG. 3 is a diagram illustrating an implementation example of a current consumption map for controlling a refrigeration system of a vehicle.

A current consumption map MAP1 may be implemented as a 3D array-type data structure (e.g., received by, accessible to and/or stored in a device for controlling a refrigeration system of a vehicle). The current consumption map MAP1 may include current amounts associated with (e.g., corresponding to, defined based on) first (e.g., X) axis data representing a difference between an internal temperature of the freezing room and an external temperature of the refrigeration system (and/or of the freezing room), second (e.g., Y) axis data representing a target internal temperature of the freezing room, and third (e.g., Z) axis data representing the type of cargo loaded into the freezing room. For example, if a temperature difference between inside and outside air is 4 degrees, the target internal temperature of the freezing room is −25° C., and the type of cargo loaded into the freezing room is frozen processed food, the expected current consumption of the freezer corresponding to the situation may be obtained as 17 amps per hour from a corresponding entry in the current consumption map MAP1. As another example, if a temperature difference between inside and outside air is 4 degrees, the target internal temperature of the freezing room is −30° C., and the type of cargo loaded into the freezing room is frozen processed food, the expected current consumption of the freezer corresponding to the situation may be obtained as 30 amps per hour from a corresponding entry of the current consumption map MAP1. That is, as the target internal temperature is lower, the expected current consumption may increase.

As another example, if a temperature difference between inside and outside air is −20 degrees, the target internal temperature of the freezing room is −25° C., and the type of cargo loaded into the freezing room is frozen processed food, the expected current consumption of the freezer corresponding to the situation may be obtained as 8 amps per hour from a corresponding entry of the current consumption map MAP1. As another example, if the type of cargo loaded into the freezing room is frozen fish, the expected current consumption may be set to a different value than if the type of cargo is frozen processed food (e.g., have different third (e.g., Z) axis data) in the same first (e.g., X) axis data and second (e.g., Y) axis data.

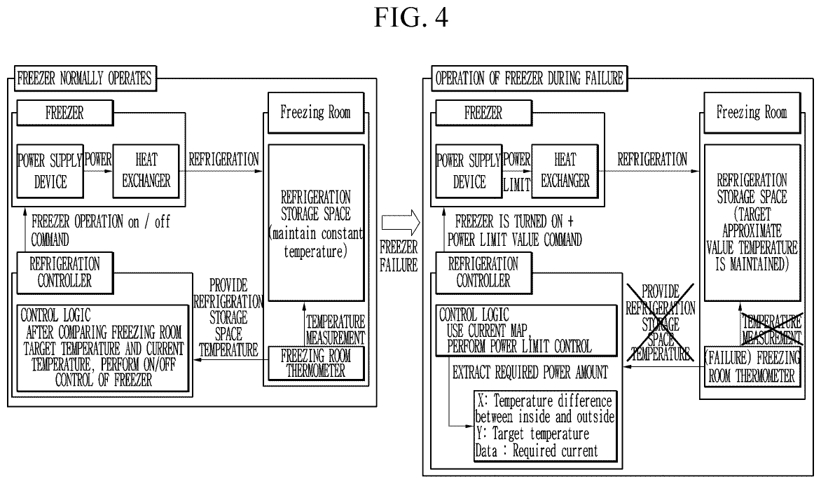

FIG. 4 is a diagram illustrating an implementation example of a device for controlling a refrigeration system of a vehicle according to an example.

Referring to FIG. 4, the device for controlling a refrigeration system of a vehicle according to an example may correspond to a refrigeration controller in the drawing. As shown on the left side of FIG. 4, during a normal operation, the refrigeration controller may modulate and/or turn the freezer on/off according to a difference between a target temperature of the freezing room and a current temperature. That is, the refrigeration controller may transmit a command to turn on/off the operation of the freezer to the power supply device of the freezing room according to the difference between the target temperature of the freezing room and the current temperature. The power supply device may provide power to the heat exchanger according to the command received from the refrigeration controller and freeze the freezing room. A freezing room thermometer (corresponding to the freezing room temperature sensor) may be installed in the freezing room to measure an internal temperature of the freezing room (e.g., a temperature of a storage space, in the freezing room, of a frozen product), and provide the measured temperature to the refrigeration controller.

If a failure occurs while the freezer operates normally (e.g., during normal operation mode), the operation mode of the freezer may be switched to an in-failure operation, as shown on the right side of FIG. 4. In this case, the freezing room thermometer may not be able to measure the internal temperature of the freezing room and/or may not be able to provide the measured temperature and/or an accurately measured temperature to the refrigeration controller. In this case, the refrigeration controller may perform power limit control for the freezer using a current map, which may include information corresponding an internal and external temperature difference, a target temperature, and a required current amount to achieve the target temperature given the internal and external temperature difference. That is, the refrigeration controller may transmit a command regarding a power limit value to the power supply device, while transmitting a command to turn on the operation of the freezer to the power supply device of the freezer. The power supply device may operate, while providing limited power to the heat exchanger, according to the command received from the refrigeration controller. Accordingly, without a feedback on the temperature of the freezing room, the freezing room may be operated based on a constant current amount, so that not only may refrigerated cargo be prevented from being damaged (e.g., thawed or excessively frozen), but it is also possible to temporarily operate the vehicle for a given time or to a destination without making an emergency turn and/or stop or redirection. Accordingly, economic and time loss that may occur when the refrigeration system malfunctions while the vehicle is in operation may be minimized.

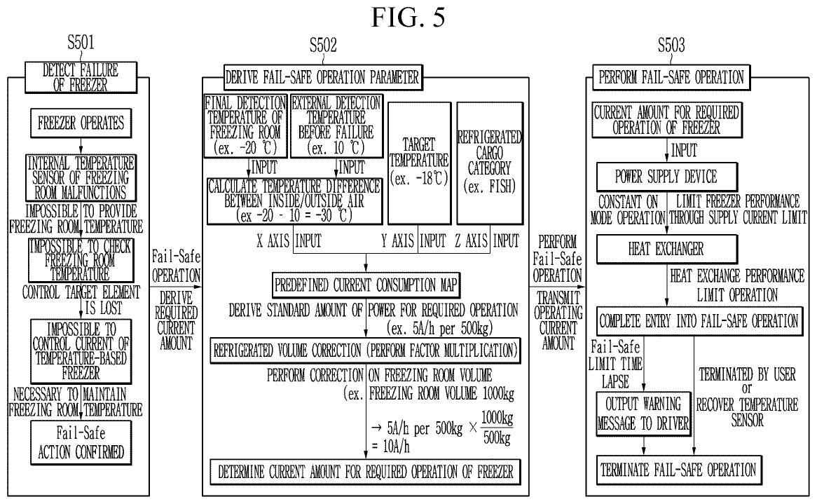

FIG. 5 is a diagram illustrating an implementation example of a method for controlling a refrigeration system of a vehicle according to an example.

Referring to FIG. 5, the method for controlling a refrigeration system of a vehicle according to an example includes detecting a failure of the refrigeration system (S501), deriving a fail-safe operation parameter (S502), and performing a fail-safe operation (S503).

In operation S501, if the temperature sensor inside the freezing room malfunctions during an operation of the freezing room, or if communication of a reding from the temperature sensor malfunctions, for example, an internal temperature of the freezing room cannot be provided, so it may be difficult to check the temperature inside the freezing room. As a result, a control target element to be controlled may be lost, so it may be difficult to control current of the freezer based on temperature. To maintain the temperature of the freezing room, it may be determined to enter a fail-safe operation. The method may then proceed to operation S502 to derive a current amount required for a fail-safe operation.

In operation S502, a final detected temperature (e.g. −20° C.) of the freezing room and an externally detected temperature before a failure (e.g. 10° C.) may be received, and a temperature difference (e.g. −20° C.−10° C.=−30° C.) between the inside air and the outside air may be determined/calculated. A target temperature (for example, −18° C.) of the freezing room may be set, and/or a refrigerated cargo category (for example, fish) may be set. The temperature difference, target temperature, and/or refrigerated cargo category may be compared to/input into the predefined current consumption map (e.g., the first (X) axis, the second (Y) axis and/or the third (Z) axis, respectively). A corresponding amount (e.g., the standard amount, for example, 5 A/h per 500 kg) of power required for an operation (e.g., per volume or mass of refrigerated cargo) may be derived. A refrigerated volume may be used in a correction factor to arrive at a final amount of power required for the operation. For example, if the expected current consumption (based on the current consumption map) is 5 A/h per 500 kg, a current amount required to operate the freezer may be determined to be 10 A/h by applying a correction factor of 2 considering that the freezing room volume is 1000 kg (1000 kg/500 kg of the standard amount from the current consumption map). In operation S503, an indication of the amount of operating current for performing the fail-safe operation may be transmitted.

In operation S503, if the current amount required to operate the freezer may be input to the power supply device, the power supply device may operate in a constant ON mode, but the performance of the freezer may be limited by limiting the supply current. Accordingly, the heat exchanger may also perform an operation with limited heat exchange capacity, thereby completing entry into the fail-safe operation. If a fail-safe limit time has lapsed, a warning message may be output to a driver, and the fail-safe operation may be terminated. Also, or alternatively, the fail-safe operation may be terminated based on a user terminating the operation and/or the temperature sensor being recovered.

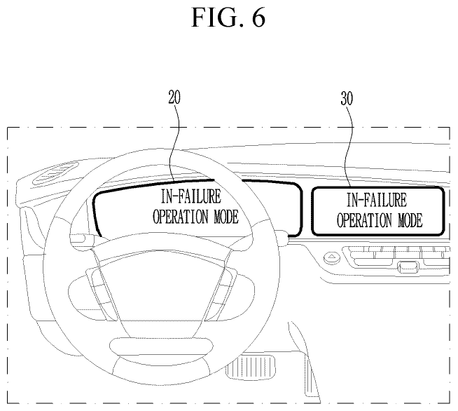

FIG. 6 is a diagram illustrating an implementation example of a device for controlling a refrigeration system of a vehicle according to an example.

Referring to FIG. 6, in the device for controlling a refrigeration system, if a failure of the refrigeration system is detected while the vehicle is in operation and/or if the freezer is being operated in the in-failure operation mode, a notification indicating that the refrigeration system is operated/being operated during a failure may be output via one or more interfaces (e.g., shown as a plurality of interfaces, for example, a cluster 20, a center fascia 30, etc.) of in the vehicle. Of course, although not shown in FIG. 6, the notification may be output through other display devices within the vehicle and/or associated with a driver of the vehicle (e.g., a wirelessly connected device, such as a smart phone, in communication with the vehicle), without being limited to the cluster 20 and the center fascia 30. Accordingly, the driver may immediately recognize the failure of the freezer while driving the vehicle and take appropriate actions.

FIG. 7 is a diagram illustrating a computing device according to an example.

Referring to FIG. 7, a method and device for controlling a refrigeration system of a vehicle according to examples may be implemented using a computing device 50.

The computing device 50 may include at least one of a processor 510, a memory 530, a user interface input device 540, a user interface output device 550, and a storage device 560 communicating with each other via a bus 520. The computing device 50 may also include a network interface 570 electrically connected to a network 40. The network interface 570 may transmit or receive signals to and from other entities through the network 40.

The processor 510 may be implemented as various types, such as a micro controller unit (MCU), an application processor (AP), a central processing unit (CPU), a graphic processing unit (GPU), a neural processing unit (NPU), and a quantum processing unit (QPU), and may be a semiconductor device that executes instructions stored in the memory 530 or the storage device 560. The processor 510 may be configured to implement the functions and methods described above with respect to FIGS. 1 to 6.

The memory 530 and the storage device 560 may include various types of volatile or non-volatile storage mediums. For example, the memory may include read-only memory (ROM) 531 and random access memory (RAM) 532. In some examples, the memory 530 may be located inside or outside the processor 510, and the memory 530 may be connected to the processor 510 through various known units.

In some examples, at least some components or functions of the method and device for controlling a refrigeration system of a vehicle according to the examples may be implemented as a program or software running on the computing device 50, and the program or software may be stored in a computer-readable medium. Specifically, the computer-readable medium according to an example may record a program for executing the operations included in the method and device for controlling a refrigeration system of a vehicle according to an example on a computer including the processor 510 that executes a program or command stored in the memory 530 or the storage device 560.

In some examples, at least some components or functions of the method and device for controlling a refrigeration system of a vehicle according to examples may be implemented using hardware or circuits of the computing device 50 or may be implemented using separate hardware or circuits that may be electrically connected to the computing device 50.

The disclosure attempts to provide a method and device for controlling a refrigeration system of a vehicle capable of minimizing damage to refrigerated cargo loaded in a freezing room by operating a freezer, which controls the temperature of the freezing room, in a restricted state for a certain period of time when a malfunction occurs in the refrigeration system of a vehicle while the vehicle is in operation.

According to an example, a method for controlling a refrigeration system of a vehicle, which controls a freezer controlling a temperature of a freezing room when the refrigeration system installed in the vehicle malfunctions, includes: detecting a failure of the refrigeration system while the vehicle is in operation; receiving a predefined current consumption map for the refrigeration system; when a failure of the refrigeration system is detected, calculating an in-failure operating current amount for controlling an operation of the freezer during a failure based on a current consumption derived from the current consumption map; and transmitting both the in-failure operating current amount and an operating command of the freezer to a power supply device of the freezer to switch an operation mode of the refrigeration system from a normal operation mode to an in-failure operation mode so that the power supply device limits power used in a heat exchanger.

In some example, the current consumption map may be generated by defining a current amount required to achieve a target internal temperature of the freezing room based on at least one of an external temperature of the refrigeration system, an internal temperature of the freezing room, a target internal temperature of the freezing room, and a type of cargo loaded in the freezing room.

In some example, the current consumption map may be defined based on an X axis representing a difference between the internal temperature of the freezing room and the external temperature of the refrigeration system, a Y axis representing the target internal temperature of the freezing room, and a Z axis representing the type of cargo loaded in the freezing room.

In some example, the calculating of an in-failure operating current amount may include applying a correction factor for considering a cargo volume loaded in the freezing room to the current consumption and calculating the current consumption to which the correction factor is applied as the in-failure operating current amount.

In some example, the detecting of a failure of the refrigeration system may include determining that the refrigeration system malfunctions when a failure signal is received from the freezing room temperature sensor.

In some example, the detecting of a failure of the refrigeration system may include tracking a temperature change in the freezing room and determining that the refrigeration system malfunctions when the change is analyzed to be an abnormal change.

In some example, the method for controlling a refrigeration system of a vehicle may further include: outputting a notification indicating that the refrigeration system is operating during a malfunction through a plurality of interfaces installed in the vehicle.

In some example, the method for controlling a refrigeration system of a vehicle may further include: when a predetermined limit time has elapsed since the operation mode of the refrigeration system was switched to the in-failure operation mode, terminating the in-failure operation mode.

In some example, the method for controlling a refrigeration system of a vehicle may further include: outputting a notification regarding termination of the in-failure operation mode through a plurality of interfaces installed in the vehicle.

In some example, the method for controlling a refrigeration system of a vehicle may further include: when the failure is resolved, switching the operation mode of the refrigeration system from the in-failure operation mode to the normal operation mode.

According to another example, a device for controlling a refrigeration system of a vehicle, which controls a freezer controlling a temperature of a freezing room when the refrigeration system installed in the vehicle malfunctions, which executes a program code loaded in one or more memory devices through one or more processors, wherein the program code is executed to detect a failure of the refrigeration system while the vehicle is in operation, receive a predefined current consumption map for the refrigeration system, calculate an in-failure operating current amount for controlling an operation of the freezer during a failure based on a current consumption derived from the current consumption map, when a failure of the refrigeration system is detected, and transmit both the in-failure operating current amount and an operating command of the freezer to a power supply device of the freezer to switch an operation mode of the refrigeration system from a normal operation mode to an in-failure operation mode so that the power supply device limits power used in a heat exchanger.

In some example, the current consumption map may be generated by defining a current amount required to achieve a target internal temperature of the freezing room based on at least one of an external temperature of the refrigeration system, an internal temperature of the freezing room, a target internal temperature of the freezing room, and a type of cargo loaded in the freezing room.

In some example, the current consumption map may be defined based on an X axis representing a difference between the internal temperature of the freezing room and the external temperature of the refrigeration system, a Y axis representing the target internal temperature of the freezing room, and a Z axis representing the type of cargo loaded in the freezing room.

In some example, the calculating of an in-failure operating current amount may include applying a correction factor for considering a cargo volume loaded in the freezing room to the current consumption and calculating the current consumption to which the correction factor is applied as the in-failure operating current amount.

In some example, the detecting of a failure of the refrigeration system may include determining that the refrigeration system malfunctions when a failure signal is received from the freezing room temperature sensor.

In some example, the detecting of a failure of the refrigeration system may include tracking a temperature change in the freezing room and determining that the refrigeration system malfunctions when the change is analyzed to be an abnormal change.

In some example, the program code may be executed to output a notification indicating that the refrigeration system is operating during a malfunction through a plurality of interfaces installed in the vehicle.

In some example, the program code may be executed to, when a predetermined limit time has elapsed since the operation mode of the refrigeration system was switched to the in-failure operation mode, terminate the in-failure operation mode.

In some example, the program code may be executed to output a notification regarding termination of the in-failure operation mode through a plurality of interfaces installed in the vehicle.

In some example, the program code may be executed to, when the failure is resolved, switch the operation mode of the refrigeration system from the in-failure operation mode to the normal operation mode.

In at least some refrigeration systems of vehicles, if a refrigeration system malfunctions while the vehicle is in operation, the condition of a refrigerated cargo cannot be guaranteed, so the vehicle may have to be urgently moved to a nearby refrigerated warehouse or an alternative refrigeration vehicle may need to be urgently prepared, thereby incurring significant economical and time losses to companies or vehicle drivers providing logistics or cargo services. In addition, even during emergency movement, the refrigeration system cannot operate at a constant temperature, so refrigerated cargo may melt or be excessively frozen and damaged.

According to examples, when the refrigeration system of a vehicle malfunctions while the vehicle is in operation, the amount of current or power applied to the freezer is limited and a target refrigeration temperature is maintained for a certain period of time, thereby solving the above problems and minimizing economic loss.

While the disclosure has been described in connection with examples, it is to be understood that the present disclosure is not limited to the disclosed examples, but, on the contrary, is intended to cover various modifications and equivalent arrangements included within the spirit and scope of the appended claims.

What is claimed is:

1. A method for controlling a refrigeration system of a vehicle, the method comprising:
detecting a failure of the refrigeration system comprising a freezer configured to control a temperature of a freezing room of the refrigeration system;
receiving a current consumption map, for the refrigeration system, mapping current amounts to target temperatures of the freezing room;
based on the detected failure of the refrigeration system, determining, using the current consumption map, an in-failure operating current amount for controlling an operation of the freezer of the refrigeration system during the failure; and
transmitting, to a power supply device of the freezer:
the in-failure operating current amount, and
an operating command configured to cause the power supply device to switch from a normal operation mode to an in-failure operation mode in which the power supply device limits, relative to the normal operation mode, power used in a heat exchanger of the freezer.

2. The method of claim 1, wherein:
the current consumption map further maps the current amounts, to at least one of an external temperature of the refrigeration system, an internal temperature of the freezing room or a type of cargo loaded in the freezing room.

3. The method of claim 2, wherein:
the current consumption map comprises a first axis representing a difference between the internal temperature of the freezing room and the external temperature of the refrigeration system, a second axis representing the target temperatures of the freezing room, and a third axis representing the type of cargo loaded in the freezing room, and wherein each current amount is mapped to a coordinate of the first axis, a coordinate of the second axis and a coordinate of the third axis.

4. The method of claim 1, wherein:
the determining the in-failure operating current amount comprises:
applying a correction factor, based on a cargo volume loaded in the freezing room, to a current amount of the current consumption map.

5. The method of claim 1, wherein:
the detecting the failure of the refrigeration system comprises:
receiving a failure signal from a freezing room temperature sensor.

6. The method of claim 1, wherein:
the detecting the failure of the refrigeration system comprises:
tracking a temperature change in the freezing room and determining the temperature change is an abnormal change.

7. The method of claim 1, further comprising:
outputting, via one or more interfaces of the vehicle, a notification indicating that the refrigeration system is operating during a malfunction.

8. The method of claim 1, further comprising:
based on a limit time elapsing since the power supply device switched from the normal operation mode to the in-failure operation mode, terminating the in-failure operation mode.

9. The method of claim 8, further comprising:
outputting, via one or more interfaces of the vehicle, a notification regarding the terminating of the in-failure operation mode.

10. The method of claim 1, further comprising:
causing, based on the failure being resolved, the power supply device to switch from the in-failure operation mode to the normal operation mode.

11. A device for controlling a refrigeration system of a vehicle, wherein the device comprises:
one or more processors; and
one or more memory devices comprising at least one instruction that, when executed by the one or more processors, is configured to cause the device to:
detect a failure of the refrigeration system comprising a freezer configured to control a temperature of a freezing room of the refrigeration system;
receive a current consumption map, for the refrigeration system, mapping current amounts to target temperatures of the freezing room;
based on the detected failure of the refrigeration system, determine, using the current consumption map, an in-failure operating current amount for controlling an operation of the freezer of the refrigeration system during the failure; and
transmit, to a power supply device of the freezer:
the in-failure operating current amount, and
an operating command configured to cause the power supply device to switch an operation mode of the refrigeration system from a normal operation mode to an in-failure operation mode in which the power supply device limits, relative to the normal operation mode, power used in a heat exchanger of the freezer.

12. The device of claim 11, wherein:
the current consumption map further maps the current amounts, to at least one of an external temperature of the refrigeration system, an internal temperature of the freezing room or a type of cargo loaded in the freezing room.

13. The device of claim 12, wherein:
the current consumption map comprises a first axis representing a difference between the internal temperature of the freezing room and the external temperature of the refrigeration system, a second axis representing the target temperatures of the freezing room, and a third axis representing the type of cargo loaded in the freezing room, and wherein each current amount is mapped to a coordinate of the first axis, a coordinate of the second axis and a coordinate of the third axis.

14. The device of claim 11, wherein:
the at least one instruction, when executed by the one or more processors, is configured to cause the device to determine the in-failure operating current amount by:
applying a correction factor, based on a cargo volume loaded in the freezing room, to a current amount of the current consumption map.

15. The device of claim 11, wherein:
the at least one instruction, when executed by the one or more processors, is configured to cause the device to detect the failure of the refrigeration system by:
receiving a failure signal from a freezing room temperature sensor.

16. The device of claim 11, wherein:
the at least one instruction, when executed by the one or more processors, is configured to cause the device to detect the failure of the refrigeration system by:
tracking a temperature change in the freezing room and determining the temperature change is an abnormal change.

17. The device of claim 11, wherein:
the at least one instruction,, when executed by the one or more processors, is configured to output, via one or more interfaces installed in the vehicle, a notification indicating that the refrigeration system is operating during a malfunction.

18. The device of claim 11, wherein:
the at least one instruction, when executed by the one or more processors, is configured to cause the device to terminate, based on a limit time elapsing since the operation mode of the refrigeration system was switched to the in-failure operation mode, the in-failure operation mode.

19. The device of claim 18, wherein:
the at least one instruction, when executed by the one or more processors, is configured to cause the device to:
output, via one or more interfaces installed in the vehicle, a notification regarding termination of the in-failure operation mode.

20. The device of claim 11, wherein:
the at least one instruction, when executed by the one or more processors, is configured to cause the device to, based on the failure being resolved, the power supply device to switch from the in-failure operation mode to the normal operation mode.
